(19) United States
(12) Patent Application Publication
(10) Pub. No.: US 2020/0158914 A1
(43) Pub. Date: May 21, 2020

(54) MOBILE TERMINAL

(71) Applicant: Beijing Xiaomi Mobile Software Co., Ltd., Beijing (CN)

(72) Inventor: Lintao ZHANG, Beijing (CN)

(73) Assignee: Beijing Xiaomi Mobile Software Co., Ltd.

(21) Appl. No.: 16/580,715

(22) Filed: Sep. 24, 2019

(30) Foreign Application Priority Data
Nov. 19, 2018 (CN) 201811379105.7

(51) Int. Cl. G02B 1/11; G02B 1/14; B32B 7/12

(52) U.S. Cl. CPC G02B 1/11; B32B 2457/20; B32B 7/12; G02B 1/14

(57) ABSTRACT

A mobile terminal includes an optical device, a display module, and an optical antireflective film. The display module is located above the optical device. The optical antireflective film is located on the display module and corresponds to the optical device. The technical solution of the present disclosure can improve the performance of the optical device located under the display module.

### CROSS-REFERENCE TO RELATED APPLICATIONS

The present application is based on and claims priority of Chinese Patent Application No. 201811379105.7 filed on Nov. 19, 2018, which is hereby incorporated by reference in its entirety.

### TECHNICAL FIELD

This disclosure relates to the technical field of terminals, and particularly to a mobile terminal.

### BACKGROUND

With development of a full-screen technology, it may be required to arrange optical devices, such as a camera or an ambient light sensing device, beneath a display screen. Input signals of these optical devices are outside light. Energy and quality of the outside light to pass through the display screen to these optical devices may directly affect performance of the optical devices. Thus, how to improve the performance of the optical devices located beneath the display screen is a technical problem to be solved.

### SUMMARY

Embodiments of the present disclosure provide a mobile terminal for improving performance of an optical device located under the display module.

According to one aspect of the present disclosure, a mobile terminal includes an optical device, a display module, and an optical antireflective film (e.g., anti-reflection coating). The display module is located above the optical device, and the optical antireflective film is located on the display module and corresponds to the optical device.

The technical solution provided by the present disclosure may include the following advantageous effects: an optical antireflective film is provided on the display module located above the optical device, so that this can improve the energy and quality of light incident on the optical device under the display module through the display module, and also can improve the energy and quality of the light emitted by the optical device through the display module. Thus, the technical solution of the embodiment of the present disclosure can improve the performance of the optical device located under the display module.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments of the present disclosure and, together with the specification, serve to explain the principles of the disclosure.

FIG. 1 is a schematic diagram of a mobile terminal according to related art.

FIG. 2 is a schematic diagram of an optical path according to the related art.

FIG. 3 is a schematic diagram of a mobile terminal according to one example embodiment.

FIG. 4 is a schematic diagram of a cross-section of the mobile terminal according to one example embodiment.

FIG. 5 is a schematic diagram of a cross-section of a mobile terminal according to another example embodiment.

FIG. 6 is a schematic diagram of a cross-section of a mobile terminal according to another example embodiment.

FIG. 7 is a schematic diagram of a cross-section of a mobile terminal according to another example embodiment.

### DETAILED DESCRIPTION

Example embodiments will be described in detail and illustrated in the accompanying drawings. When the description hereinafter refers to the drawings, the same number in different drawings indicates the same or similar elements, unless having another indication. The implementations as described in the example embodiments do not represent all implementations in consistence with the present disclosure. Instead, these implementations are merely examples of devices and methods corresponding to some aspects of the present disclosure.

FIG. 1 is a schematic diagram of a mobile terminal according to related art. In the related art, as an increasing trend of the mobile phone with a full-screen, it is often required to place an optical device 1, such as a camera or ambient light sensing device beneath a display screen 2. A protective layer 3 may be provided above the display screen 2. The protective layer 3 may be a glass cover or a protective film or the like. Input signals of the optical device 1 are outside light. Energy and quality of the outside light passing through the display screen 2 to the optical device 1 may directly affect the performance of the optical device 1.

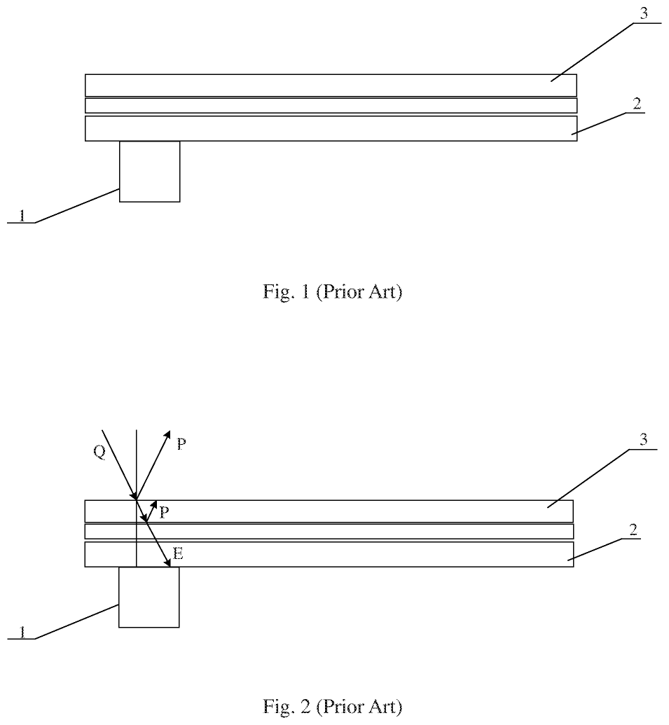

For example, a path of an incident light Q entering the optical device 1 is shown in FIG. 2. The incident light Q is reflected on upper and lower surfaces of the protective layer 3. The reflected light P loses its energy and may not enter the optical device 1. Moreover, a part of the incident light Q does not enter the optical device 1, since the energy of the part of the incident light Q is absorbed by the protective layer 3 and the display screen 2. That is, the following relationship is generally satisfied; the energy of useful light E entering the optical device 1=the energy of the incident light—the energy of the reflected light—the energy of the light absorbed by the protective layer 3 and the display screen 2.

The reflected light is formed due to refraction/reflection of air and the protective layer 3. If the protective layer 3 is a glass cover, and a typical refractive index of the glass is n_{glass}=1.5, and a reflectivity R_{glass}=(n_{glass}−nₐᵢᵣ)²/(n_{glass}+nₐᵢᵣ)², the reflectivity R_{glass}=4% will be obtained. Since the incident light Q enters the protective layer 3 from the air and enters the air from the protective layer 3, at least two reflections occur while entering the optical device 1. As a result, about 8% of incident light will be lost due to the reflections.

Embodiments of the present disclosure provide a mobile terminal, to solve the above technical problems, and may improve the performance of optical devices located beneath a display module.

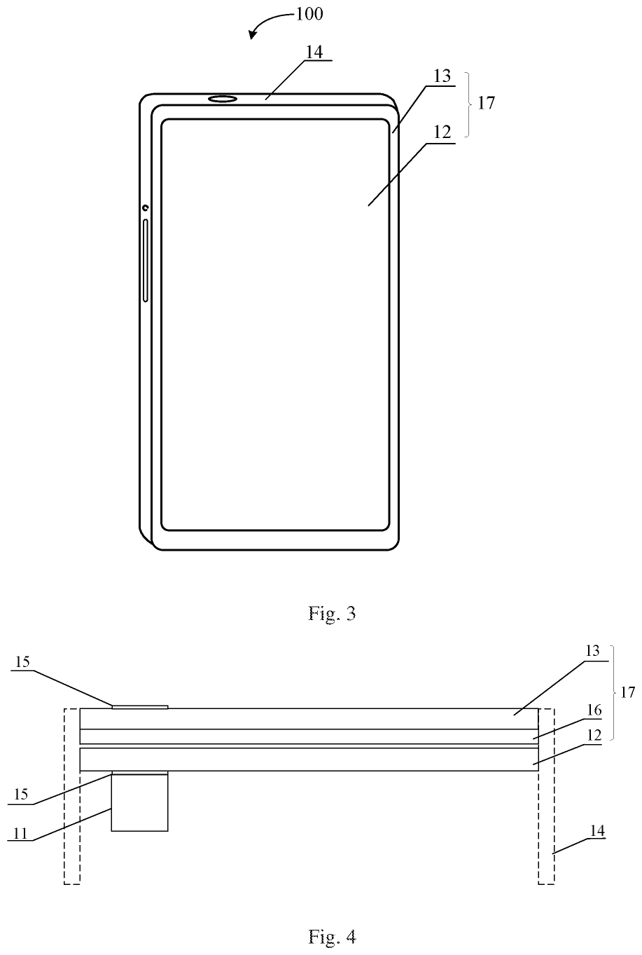

FIG. 3 is a schematic diagram of a mobile terminal 100 according to one example embodiment. The mobile terminal 100 includes a housing 14 and a display module 17. The display module 17 is located in the housing 14. The display module 17 includes a transparent protective layer 13 and a display screen 12 located beneath the protective layer 13. Light emitted from the display screen 12 may transmit through the protective layer 13. The display screen 12 may be observed through the transparent protective layer 13. The display screen 12 may be, for example, an organic light-emitting diode (OLED) display screen, but not limited thereto. When the mobile terminal 100 is an upright mobile terminal, the protective layer 13 may be a glass cover. When the mobile terminal 100 is a foldable flexible screen mobile terminal, the protective layer 13 may be a flexible cover film. The flexible cover film may include a polyimide (PI) film.

FIGS. 4-7 are schematic diagrams of a cross-section of the mobile terminal 100 according to example embodiments of the present disclosure. As shown in FIGS. 4-7, the mobile terminal 100 further includes an optical device 11 and an optical antireflective film 15.

As shown in FIGS. 4-7, the display module 17 is located above the optical device 11. The optical antireflective film 15 is located on the display module 17 and corresponds to the optical device 11. The optical antireflective film 15 is located on the display module 17, which includes circumstances below: the optical antireflective film 15 is located on the surface of the display module 17 facing away from the optical device 11; the optical antireflective film 15 is located on the surface of the display module 17 facing to the optical device 11, and the optical antireflective film 15 is located inside the display module 17.

In one embodiment, the optical device 11 may be an image sensor (e.g., camera), an ambient optical device, a 3D distance sensor, or a fingerprint sensor. The 3D distance sensor may be a 3D structure optical device, which may be an infrared lens (e.g., infrared emitter), a floodlight sensing element or a dot matrix projector. In one embodiment, there are a plurality of optical devices 11.

It should be noted that, in the embodiment of the present disclosure, the above-mentioned “above” refers to a direction of the optical device 11 directing to the display module 17.

In the embodiment of the present disclosure, the optical antireflection film is provided on the display module located above the optical device, in this way, the energy and quality of the light transmitted through the display module to the optical device located under the display module may be improved, and also the energy and quality of the light emitted by the optical device through the display module may be improved. As a result, the technical solution of the embodiment of the present disclosure can improve the performance of the optical device located under the display module.

In one embodiment, as shown in FIG. 4, the display module 17 may include a display screen 12 and a protective layer 13. The display screen 12 is located above the optical device 11, and the protective layer 13 is located above the display screen 12.

In one embodiment, as shown in FIG. 4, the optical antireflection film 15 is located on the surface of the protective layer 13 facing away from the display screen 12. For example, when the light is transmitted from the outside to the optical antireflective film 15, the light reflected from the surface of the optical antireflective film 15 facing away from the protective layer 13 (the upper surface) interferes with the light reflected from the surface of the optical antireflective film facing to the protective layer 13 (the lower surface), and thereby canceling each other. When viewed toward the upper surface of the optical antireflective film 15, no reflected light is visible because the incident light has completely passed through the protective layer 13 according to the conservation of energy. Thus, the optical antireflective film 15 is arranged on the upper surface of the protective layer 13, which can improve the energy and quality of light transmitting through the protective layer 13, and further improve the energy and quality of the light transmitted into the optical device located beneath the display module through the display module.

In one embodiment, as shown in FIG. 4, the optical antireflective film 15 is located on the surface of the display screen 12 facing the optical device 11. For example, when the optical device 11 emits light, the light emitted from the optical device 11 is transmitted to the optical antireflective film 15, and then the light reflected from the surface of the optical antireflective film 15 facing away from the display screen 12 (the lower surface) interferes with the light reflected from the surface of the optical antireflective film facing the display screen 12 (the upper surface), thereby canceling each other. When viewed toward the lower surface of the optical antireflective film 15, no reflected light is visible because the light emitted from the optical device 11 has completely passed through the display screen 12 according to the conservation of energy. Thus, the optical antireflective film 15 is arranged on the lower surface of the display screen 12, which can improve the energy and quality of light emitted from the optical device through the display screen 12.

It should be noted that the optical antireflective film 15 has wavelength selectivity for the light to be anti-reflected. When the optical antireflective film 15 has different thicknesses, the lights to be anti-reflected have different wavelengths. For example, when the thickness of the optical antireflective film 15 is odd times of ¼ wavelength of a red light, the red lights reflected from the two surfaces of the optical antireflective film interfere with each other, thereby canceling each other. When viewed toward the upper surface of the optical antireflective film 15, no reflected red light is visible because the red light in the incident light has completely passed through the protective layer 13 according to the conservation of energy. However, when the thickness of the optical antireflective film 15 is odd times of ¼ wavelength of the red light, the violet light will not certainly be anti-reflected.

In one embodiment, the optical antireflective film 15 may include at least two sub-film layers, which may respectively anti-reflect the lights with different wavelength ranges. In this way, more bands of light can be anti-reflected. For example, the wavelength range of the visible light is 380-700 nm and the optical antireflective film 15 includes three sub-film layers. The optical antireflective film 15 may include a first sub-film layer, a second sub-film layer, and a third sub-film layer stacked one another. In this embodiment, according to a relationship between the thickness of the film layer and the wavelength, the first sub-film layer may be made to anti-reflect the light with a wavelength of 380-450 nm, the second sub-film layer may be made to anti-reflect the light with a wavelength of 451-550 nm, and the third sub-film layer may be made to anti-reflect the light with a wavelength of 551-700 nm. In this way, the light in a full range of visible light can be anti-reflected, to improve the energy and quality of the visible light transmitted into the optical device under the display screen, or to improve the energy and quality of the visible light emitted by the optical device through the display screen. It should be noted that the above-mentioned numbers do not limit the disclosure.

In one embodiment, as shown in FIG. 4, the display module 17 may further include a transparent adhesive layer 16. The transparent adhesive layer 16 is located between the display screen 12 and the protective layer 13. The transparent adhesive layer 16 may be made of optically clear adhesive (OCA), for bonding the protective layer 13 and the display screen 12.

In one embodiment, as shown in FIG. 5, when a difference between the refractive index of the transparent adhesive layer 16 and the refractive index of the protective layer 13 is greater than 0.1, the optical antireflective film 15 may be provided between the protective layer 13 and the transparent adhesive layer 16. A difference between the refractive index of the protective layer 13 and the refractive index of the optical antireflective film 15 may be greater than 0.1, and a difference between the refractive index of the transparent adhesive layer 16 and the refractive index of the optical antireflective film 15 may be greater than 0.1. When the difference between the refractive index of the transparent adhesive layer 16 and the refractive index of the protective layer 13 is greater than 0.1, the incident light will be reflected at an interface between the transparent adhesive layer 16 and the protective layer 13. Thus, the optical antireflective film 15 is provided between the transparent adhesive layer 16 and the protective layer 13, which can improve the performance of the optical device located beneath the display module.

In an example embodiment, the protective layer 13 is a flexible cover film. The flexible cover film includes a polyimide (PI) film. The material of the transparent adhesive layer 16 is OCA. Since a refractive index of the PI film is greater than 1.68 and a refractive index of the OCA is 1.48, the difference between the refractive index of the transparent adhesive layer 16 and the refractive index of the protective layer 13 is greater than 0.2, which is also greater than 0.1. The incident light will be reflected at the interface between the transparent adhesive layer 16 and the protective layer 13. Thus, the optical antireflective film 15 is provided between the transparent adhesive layer 16 and the protective layer 13, which can improve the performance of the optical device under the display module.

It should be noted that when the protective layer 13 is a glass cover and the material of the transparent adhesive layer 16 is OCA, since the refractive index of the glass cover is 1.5, and the refractive index of the OCA is about 1.48, the difference between the refractive index of the transparent adhesive layer 16 and the refractive index of the protective layer 13 is 0.02, which is less than 0.1. The incident light may not be reflected at the interface between the transparent adhesive layer 16 and the protective layer 13. Thus, the optical antireflective film 15 may not be provided between the transparent adhesive layer 16 and the protective layer 13.

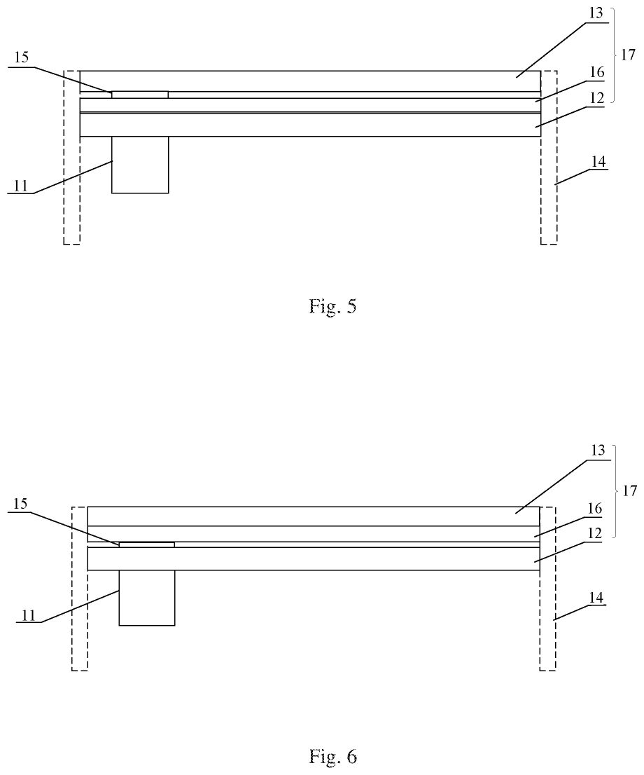

In one embodiment, as shown in FIG. 6, when the difference between the refractive index of the transparent adhesive layer 16 and the refractive index of the display screen 12 is greater than 0.1, the optical antireflective film 15 may be provided between the transparent adhesive layer 16 and the display screen 12, wherein the difference between the refractive index of the transparent adhesive layer 16 and the refractive index of the optical antireflective film 15 may be greater than 0.1, and the difference between the refractive index of the display screen 12 and the refractive index of the optical antireflective film 15 may be greater than 0.1. When the difference between the refractive index of the transparent adhesive layer 16 and the refractive index of the display screen 12 is greater than 0.1, the incident light will be reflected at the interface between the transparent adhesive layer 16 and the display screen 12. Thus, the optical antireflective film 15 is provided between the transparent adhesive layer 16 and the display screen 12, which can improve the performance of the optical device under the display module.

In one example embodiment, the refractive index of the transparent adhesive layer 16 is 1.5, and the refractive index of the display screen 12 is 1.7, so that the difference between the refractive index of the transparent adhesive layer 16 and the refractive index of the display screen 12 is 0.2, which is greater than 0.1. The incident light will be reflected at the interface between the transparent adhesive layer 16 and the display screen 12. Thus, the optical antireflective film 15 is provided between the transparent adhesive layer 16 and the display screen 12, which can improve the performance of the optical device under the display module.

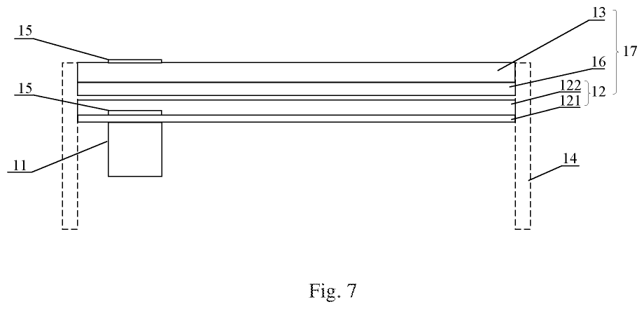

In one embodiment, as shown in FIG. 7, display screen 12 may include at least two media layers. Light can spread within a media layer and transmit through the media layer. Each of the at least two media layers may have the same or different refractive index for light with the same frequency. In at least two media layers, the optical antireflective film 15 may be disposed between the adjacent two media layers having a difference of refractive indexes greater than 0.1. The incident light will be reflected at the interface between the adjacent two media layers having a difference in refractive indexes greater than 0.1. Thus, the optical antireflective film 15 is provided between the adjacent two media layers having the difference in refractive indexes greater than 0.1, which can improve the performance of the optical device under the display module.

In one embodiment, the display screen 12 includes two media layers. As shown in FIG. 7, the display screen 12 includes a first media layer 121 and a second media layer 122, and the difference between the refractive index of the first media layer 121 and the refractive index of the second media layer 122 is greater than 0.1. The incident light will be reflected at the interface between the first media layer 121 and the second media layer 122. Thus, the optical antireflective film 15 is provided between the first media layer 121 and the second media layer 122, which can improve the performance of the optical device under the display module.

In one embodiment, an area of the optical antireflective film 15 is equal to a projected area of the optical device 11 on the display module 17. The area of the optical antireflective film 15 may also be larger than the projected area of the optical device 11 on the display module 17.

In one embodiment, the material of the optical antireflective film may include calcium fluoride, titanium oxide, lead sulfide, lead selenide, ceramic infrared antireflection film or vinyl silsesquioxane hybrid film, but not limited thereto.

The above-mentioned optical antireflective film and the principle of antireflection will be further described below.

Firstly, it should be noted that light has wave-particle duality, that is, microscopically, the light may be understood as a kind of wave, but also a bunch of high-speed moving particles. The wavelength of the red light is 0.750 micron and the wavelength of the violet light is 0.400 micron, and the quality of a photon is 6.63E⁻³⁴ kilograms. Accordingly, the above wave and particle are evidently not the macro waves and particles as imagined. The principle of optical antireflective film is considered by taking the light as a kind of wave, since the light wave has an interference property as same as the mechanical wave. The optical antireflective film utilizes the interference principle of the light such that the light reflected by the front surface of the film interferes with the light reflected by the back surface of the film, to change light intensity of a transmission region by changing the light intensity of the reflection region.

In an optical instrument, reflection of the surface of the optical element affects the light-passing energy of the optical element, but also the reflected light forms a stray light in the instrument, to affect the imaging quality of the optical instrument. In order to solve this problem, a single-layer film or a multilayer film with a certain thickness can be coated on the surface of the optical element in order to reduce the reflected light on the surface of the optical element, and such film is called as an optical antireflective film (or an antireflection film).

Secondly, the antireflection principle of the optical antireflective film is analyzed from a view of the energy conservation. Generally, when light is transmitted to the surface of an optical element in a given material, the energy of the generated reflected light and of the transmitted light are determined. The total energy of the reflected light and the transmitted light is equal to the energy of the incident light without considering absorption, scattering and other factors. That is, the law of conservation of energy is satisfied. When the surface of the optical element is coated with the optical antireflective film, the reflected light and the transmitted light as well as the incident light still satisfy the law of the energy conservation without considering the absorption and scattering of the optical antireflective film and other factors. The coating film has a function of redistributing the energy of the reflected light and the energy of the transmitted light. For the optical antireflective film, as a result of the distribution, the energy of the reflected light is reduced, and the energy of the transmitted light is increased. As can be seen, the role of the optical antireflective film is to redistribute the energy of the reflected light and the energy of the transmitted light on the surface of the optical element, due to the result of the distribution, the transmitted light energy is increased, and the reflected light energy is reduced. Accordingly, the optical antireflective film has such characteristic that the light intensity of the transmission region can be changed by changing the light intensity of the reflection region.

As above described, the optical antireflective film increases the transmitted light intensity substantively in that: during the light wave as an electromagnetic wave spreads, the distribution of the energy is changed at the interface of different medias due to different boundary conditions. For the single-layer optical antireflective film, since the medias on both sides of the optical antireflective film are different, and when the thickness of the optical antireflective film is an odd times of ¼ wavelength and the refractive index of the optical antireflective film is n=(n1*n2)^{1/2}, all of the incident light may be transmitted through the media 2. Wherein, n1 and n2 are respectively the refractive indices of the media 1 and the media 2, and the media 1 and the media 2 are the medias on both sides of the optical antireflective film, and the light transmits through the media 1, the optical antireflective film and the media 2 in turn. For example, an optical lens (media 2) is generally used in air (media 1). For the optical lens with a refractive index of about 1.5, it can be made that n=1.23, or close to 1.23, and that the thickness of the optical antireflective film=one quarter wavelength of (2k+1) times, wherein k is a non-negative integer, in order to achieve a 100% antireflection effect of a single-layer optical antireflective film.

Other embodiments of the disclosure will be apparent to those skilled in the art from consideration of the specification and practice of the disclosure disclosed here. This disclosure is intended to cover any variations, uses, or adaptations of the disclosure following the general principles of the present disclosure and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and various modifications and changes may be made without departing from the scope of the present disclosure. The scope of the disclosure should only be limited by the appended claims.

What is claimed is:

1. A mobile terminal, comprising:
an optical device;
a display module; and
an optical antireflective film;
wherein the display module is located above the optical device, and the optical antireflective film is located on the display module and corresponds to the optical device.

2. The mobile terminal according to claim 1, wherein the display module comprises a display screen and a protective layer; and
the display screen is located above the optical device, and the protective layer is located above the display screen.

3. The mobile terminal according to claim 2, wherein the optical antireflective film is located on a surface of the protective layer facing away from the display screen.

4. The mobile terminal according to claim 2, wherein the optical antireflective film is located on a surface of the display screen facing to the optical device.

5. The mobile terminal according to claim 2, wherein the display module further comprises a transparent adhesive layer; and
the transparent adhesive layer is located between the display screen and the protective layer.

6. The mobile terminal according to claim 5, wherein a difference between a refractive index of the transparent adhesive layer and a refractive index of the protective layer is greater than 0.1, and the optical antireflective film is provided between the protective layer and the transparent adhesive layer.

7. The mobile terminal according to claim 5, wherein a difference between the refractive index of the transparent adhesive layer and the refractive index of the display screen is greater than 0.1, and the optical antireflective film is provided between the display screen and the transparent adhesive layer.

8. The mobile terminal according to claim 2, wherein the display screen comprises at least two media layers; and
the optical antireflective film is disposed between two adjacent media layers of the at least two media layers, a difference in refractive indexes of the two adjacent media layers being greater than 0.1.

9. The mobile terminal according to claim 1, wherein an area of the optical antireflective film is greater than or equal to a projected area of the optical device on the display module.

10. The mobile terminal according to claim 1, wherein the optical antireflective film comprises at least two sub-film layers, and the at least two sub-film layers anti-reflect lights with different wavelength ranges, respectively.

11. The mobile terminal according to claim 1, wherein the optical antireflective film is made of calcium fluoride, titanium oxide, lead sulfide, lead selenide, ceramic infrared antireflection film or vinyl silsesquioxane hybrid film.

12. The mobile terminal according to claim 2, wherein the protective layer is a glass cover or a flexible cover film.

13. The mobile terminal according to claim 12, wherein the flexible cover film comprises a polyimide film.
